(19) United States
(12) Patent Application Publication
(10) Pub. No.: US 2026/0319197 A1
(43) Pub. Date: Oct. 15, 2026

(54) Optically Coupling Optical Fibers to LEDs

(71) Applicant: Fraen Corporation, Reading, MA (US)

(72) Inventors: Carlton S. JONES, Boxford, MA (US); Kenneth DONAHUE, Middleton, MA (US); Nicodemo SCARFO, Boxford, MA (US)

(21) Appl. No.: 19/648,047

(22) Filed: Apr. 15, 2026

Related U.S. Application Data
(60) Provisional application No. 63/789,158, filed on Apr. 15, 2025.
(60) Provisional application No. 63/915,607, filed on Nov. 11, 2025.

(51) Int. Cl. G02B 6/42

(52) U.S. Cl. CPC G02B 6/424

(57) ABSTRACT

An optical system comprises a printed circuit board (PCB); a light source attached to the PCB; an optical fiber including a proximal end and a distal end; and a fiber holder configured to house the optical fiber and to receive the light source when the fiber holder is attached to the PCB, wherein the fiber holder provides a fiber-light source alignment mechanism configured to align the proximal end of the optical fiber with the light source.

### RELATED APPLICATIONS

This application claims the benefit of, and priority to, U.S. Provisional Application Nos. 63/789,158, filed Apr. 15, 2025, and 63/915,607 filed Nov. 11, 2025, both of which are entitled “Optically Coupling Optical Fibers to LEDs”, the contents of all of which are incorporated herein by reference in their entirety.

### TECHNICAL FIELD

The present disclosure relates generally to optical systems and in particular to systems and methods for efficient coupling of light generated by a light source into an optical fiber.

### BACKGROUND

Optical fibers are utilized in a variety of instruments for delivering light from a light source, e.g., an LED (light emitting diode) source, to a target. The coupling of light generated by a light source into an optical fiber is conventionally accomplished using optical components, such as lenses.

There is a need for improved methods and systems for coupling light generated by a light source into an optical fiber.

### SUMMARY

Some embodiments relate to an optical system including: a printed circuit board (PCB); a light source attached to the PCB; an optical fiber including a proximal end and a distal end; and a fiber holder configured to house the optical fiber and to receive the light source when the fiber holder is attached to the PCB, wherein the fiber holder provides a fiber-light source alignment mechanism configured to align the proximal end of the optical fiber with the light source.

Some embodiments relate to an optical system, wherein: the fiber-light source alignment mechanism includes an internal cavity defined by the fiber holder; the fiber holder is configured to position the proximal end of the optical fiber in the internal cavity; the fiber holder is configured to receive the light source inside the internal cavity when the fiber holder is attached to the PCB such that the proximal end of the optical fiber is aligned with the light source.

Some embodiments relate to an optical system, further including a module housing configured to house the fiber holder and the PCB, wherein: the module housing defines an internal gap formed between an internal wall of the module housing and an external surface of the fiber holder when the module housing houses the fiber holder; and the internal gap is configured to provide an alignment space between the module housing and the fiber holder when the fiber holder is attached to the PCB.

Some embodiments relate to an optical system, wherein: the fiber holder is as second fiber holder and the optical fiber is as second optical fiber; and the optical system further includes: a first optical fiber including a proximal end and a distal end; a first fiber holder configured to house the first optical fiber; and wherein: the first fiber holder and the second fiber holder are configured to optically connect the proximal end of the first optical fiber to the distal end of the second optical fiber when the first fiber holder is attached to the module housing.

Some embodiments relate to an optical system, further including a fiber-fiber alignment mechanism.

Some embodiments relate to an optical system, wherein: the first fiber holder includes a proximal end; the second fiber holder includes a distal end configured to attach to the proximal end of the first fiber holder when the first fiber holder is attached to the module housing; and the fiber-fiber alignment mechanism includes: a connector protrusion formed on the proximal end of the first fiber holder; and a connector recession formed on the distal end of the second fiber holder configured to receive the connector protrusion when the first fiber holder is attached to the module housing.

Some embodiments relate to an optical system, wherein: the first fiber holder connector protrusion includes a first holder proximal surface; the second fiber holder distal end includes a second holder distal surface; the first fiber holder is configured such that the proximal end of the first optical fiber protrudes from the first holder proximal surface when the first fiber holder houses the first optical fiber, forming a first optical fiber protrusion; the second fiber holder is configured such that the distal end of the second optical fiber recesses from the second holder distal surface when the second fiber holder houses the second optical fiber forming a second optical fiber recession; and the second fiber holder is configured such that when the first fiber holder is attached to the module housing the first optical fiber protrusion fits inside the second optical fiber recession.

Some embodiments relate to an optical system including: a printed circuit board (PCB); a light source attached to the PCB; an optical fiber including a proximal end and a distal end; and a fiber holder configured to: house the optical fiber and to receive the light source when the fiber holder is attached to the PCB; and receive a proximal end of an external optical fiber; wherein the fiber holder provides a fiber alignment mechanism configured to align the distal end of the optical fiber with the proximal end of the external optical fiber.

Some embodiments relate to an optical system, wherein: the fiber holder is as second fiber holder; the external optical fiber is at first optical fiber; the optical fiber is as second optical fiber; and the optical system further includes: a first fiber holder configured to house the first optical fiber; and wherein: the first fiber holder and the second fiber holder are configured to optically connect the proximal end of the first optical fiber to the distal end of the second optical fiber when the first fiber holder is attached to the module housing.

Some embodiments relate to an optical system, wherein: the first fiber holder includes a proximal end; the second fiber holder includes a distal end configured to attach to the proximal end of the first fiber holder when the first fiber holder is attached to the module housing; and the fiber-fiber alignment mechanism includes: a connector protrusion formed on the proximal end of the first fiber holder; and a connector recession formed on the distal end of the second fiber holder configured to receive the connector protrusion when the first fiber holder is attached to the module housing.

Some embodiments relate to an optical system, wherein: the first fiber holder connector protrusion includes a first holder proximal surface; the second fiber holder distal end includes a second holder distal surface; the first fiber holder is configured such that the proximal end of the first optical fiber protrudes from the first holder proximal surface when the first fiber holder houses the first optical fiber, forming a first optical fiber protrusion; the second fiber holder is configured such that the distal end of the second optical fiber recesses from the second holder distal surface when the second fiber holder houses the second optical fiber forming a second optical fiber recession; and the second fiber holder is configured such that when the first fiber holder is attached to the module housing the first optical fiber protrusion fits inside the second optical fiber recession.

In one aspect, an optical system is disclosed, which includes a light source, a first optical fiber extending from a proximal end to a distal end, said proximal end of the optical fiber positioned at a distance in a range of zero to about 1 mm relative to said light source to receive at least a portion of light emitted by said light source, and a reflective element having a light-reflecting surface and positioned between the light source and the proximal end of the optical fiber such that the light-reflecting surface can direct at least a portion of the light emitted by the light source to the proximal end of the optical fiber for entry into the optical fiber. The second optical fiber extends from a proximal end to a distal end, where the proximal end of the second optical fiber is optically coupled to the distal end of the first optical fiber to receive at least a portion of the light exiting the first optical fiber via the distal end thereof.

In various embodiments, the light reflecting surface surrounds at least a region extending from the light source to the proximal end of the first optical fiber. In various embodiments, the light reflecting surface extends beyond the proximal end of the first optical fiber to encompass a proximal segment thereof. By way of example, and without limitation, the extension of the light reflecting surface beyond the proximal end of the first optical fiber can be in a range of about 1 mm to about 20 mm.

In various embodiments, the reflective element has a truncated conical profile, though other profiles, such as a cylindrical profile, may also be employed.

In various embodiments, the reflective element can include at least one cooling window to help dissipate heat generated by the light source, e.g., a high-power LED source.

In various embodiments, the light source can be an LED source, which includes a light-emitting diode and a lens that is optically coupled to the light-emitting diode. In such embodiments, the proximal end of the first optical fiber is positioned at a distance in a range of zero and about 1 mm relative to an external surface of the lens of the LED source.

In various embodiments, the optical system can include a first holder in which the first optical fiber is disposed. In some such embodiments, the first holder can include a proximal cavity that is sized and shaped to receive at least a portion of the light source. By way of example, when the light source is an LED source, such a proximal cavity can receive the lens associated with the LED source.

In various embodiments, the optical system can further include a second holder in which the second optical fiber is positioned. The first and the second holders are configured to engage with one another so as to place the proximal end of the second optical fiber in alignment with the distal end of the first optical fiber so as to facilitate establishing an optical coupling between the two optical fibers. By way of example, the two holders can be configured such that upon engagement, the distal end of the first optical fiber will be in contact with the proximal end of the second optical fiber.

In a related aspect, an optical system is disclosed, which includes a housing in which a light source is positioned. The optical system further includes an optical fiber that extends from a proximal end to a distal end and a holder that is configured to house the optical fiber such that the engagement of the holder with the housing positions the proximal end of the optical fiber at a distance in a range of zero to about 1 mm relative to the light source. A reflective element is positioned in the housing between the light source and the proximal end of the optical fiber for reflecting at least a portion of the light emitted by the light source into the proximal end of the optical fiber so as to enter the optical fiber.

Further understanding of various aspects of the present teachings can be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 schematically depicts an optical system having an LED source that is positioned within a housing.

FIG. 2 depicts an optical system according to some embodiments.

FIG. 3 depicts another optical system according to some embodiments.

FIGS. 4A and 4B schematically illustrate an optical system according to an embodiment.

FIGS. 5A and 5B schematically depict an optical system according to another embodiment.

FIGS. 6A-6D depict an example of an optical system according to some embodiments.

FIG. 7 schematically depicts an optical system according to another embodiment.

FIG. 8A is an image of a molded component formed of Acrylic according to some embodiments.

FIG. 8B is an image of a reflective element having a truncated conical profile according to some embodiments.

FIGS. 9A through 9J demonstrate an advanced configuration that incorporates self-alignment mechanisms and modular assembly features for enhanced optical coupling performance, according to some embodiments.

FIGS. 10A through 10H, demonstrate an optical system with a connector-based configuration that incorporates modular assembly features according to some embodiments.

FIGS. 11A through 11C show an enhanced fiber-fiber alignment mechanism according to some embodiments.

FIGS. 12A and 12B show examples of measuring the adverse effect of misalignments on the efficiency according to some embodiments.

### DETAILED DESCRIPTION

The present disclosure is generally directed to optical systems that provide an efficient optical coupling between a light source and one or more optical fibers. The terms “optical fiber” and “fiber optic” are used herein interchangeably and in accordance with their ordinary meanings in the art to refer to thin thread of a light transmission medium (e.g., a glass).

The term “about” as used herein indicates a variation of at most 10% around a numerical value.

In this disclosure the term LED, an abbreviation for light-emitting diode, may also be used, for convenience, for other types of light sources, unless stated otherwise or implied otherwise from the context. For example, terms such as fiber-LED alignment, shouldn't be narrowly applied to the alignment mechanism only use for an LED as the light source, and instead should be interpreted to also apply alignment mechanisms between a fiber and other types of light sources.

A variety of conventional techniques for coupling light emitted from a light source, such as an LED source, into an optical fiber are known. For example, the current methods for coupling light from an LED source into a small optical fiber can utilize an elliptical total internal reflection (TIR) lens, an elliptical reflector, a focusing lens or lens pair for guiding the light emitted by the LED into the optical fiber.

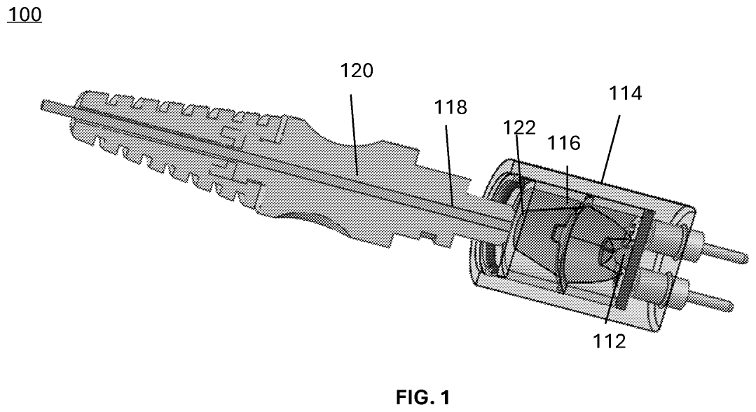

By way of example, FIG. 1 schematically depicts such a conventional optical system 100 having an LED source 112 that is positioned within a housing 114. A TIR lens 116 having an elliptical reflective surface is also positioned in the housing 114 and is optically coupled at its proximal end to the LED source 112 to receive light emitted by the LED source 112. The TIR lens is shaped so as to direct, via total internal reflection, the light received at its proximal end to its distal end, which is optically coupled to an input end of an optical fiber 118 held in a holder 120 so as to facilitate the delivery of the light exiting the TIR lens into the optical fiber. A sapphire window 122 is positioned between the output surface of the TIR lens and proximal end of the optical fiber 118.

These conventional techniques, however, suffer from several shortcomings. In particular, these techniques can be etendue-limited, that is, the focused spot of light cannot be smaller in diameter than the diameter of the light source. For example, a light source, such as LED marketed by Cree under tradename XQE, has an apparent source size of about 1.3 mm diameter. Even an infinitely large optic cannot direct all of a 1.3 mm diameter focused-light spot into a 1 mm diameter optical fiber. As a result, conventional methods can typically achieve an optical efficiency of less than 10% for coupling the light emitted by an LED into an optical fiber.

As discussed in more detail below, various embodiments do not utilize an intermediate optic (e.g., a TIR lens) positioned between a light source (e.g., an LED source) and an optical fiber, but instead position a light-receiving end of the optical fiber (herein also referred to as a proximal end of the optical fiber) in contact with, or in close proximity to, the light source (e.g., in contact or in close proximity to a light-emitting surface of the light source or a lens associated with the light source) and utilize one or more light-reflective surfaces to enhance the efficiency of the transfer of light emitted by the light source into the optical fiber. In some embodiments, as discussed in more detail below, an optical system can include a light source (e.g., an LED) that is optically coupled to a first optical fiber that is optically coupled to a light source (e.g., an LED) in a manner discussed above to receive light from the light source and a second optical fiber that is aligned with the first optical fiber so as to receive the light exiting the first optical fiber.

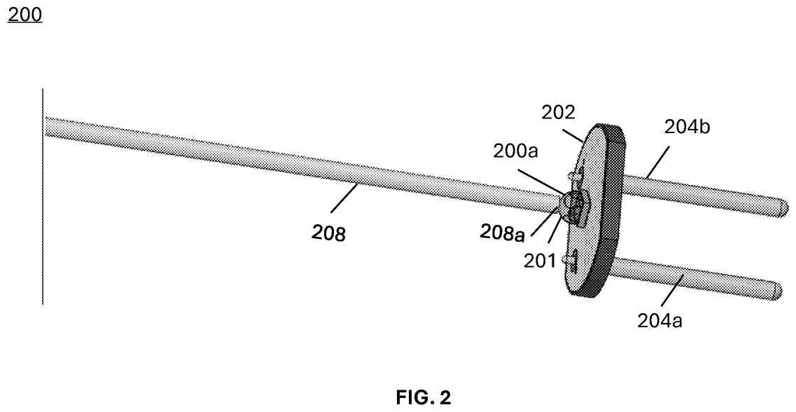

FIG. 2 depicts an optical system 200 according to some embodiments. System 200 includes an LED source 201 that is mounted on a circuit board 202 that can receive electrical power from a power source (not shown in this figure) via two electrical conductors 204a and 204b. The LED source 201 includes a silicone dome lens 200a having a hemispherical shape. An optical fiber 208 is optically coupled to the LED source 201 by placing its light-receiving (proximal end) 208a in contact with the dome lens 200a. The direct contact of the optical fiber's proximal end with the dome lens 200a can improve the efficiency of light coupling between the light source and the optical fiber. But some challenges or difficulties may exist in the alignment of the optical fiber with the light source and controlling its position relative to the lens surface, e.g., in a manner that would minimize contamination or damage of the optical fiber and the LED.

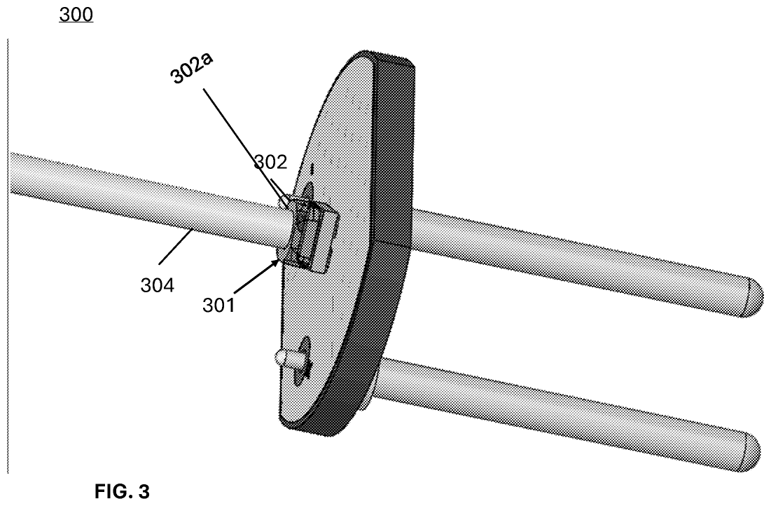

FIG. 3 depicts another optical system 300 according to some embodiments. System 300 includes an LED source 301 having a lens 302 that includes a flat top surface 302a. Flat top surface 302a may allow placing an optical fiber 304 closer to a light emitting surface of the LED source, thereby enhancing the amount of light that is received by the optical fiber. The flat surface may also facilitate the alignment of the optical fiber with the LED source. While some commercial LED sources are available with a flat or a dome lens, others may be available only with a dome lens. For those LEDs that are available only with a dome lens, a portion of the lens can be removed to provide a flat lens surface, if desired.

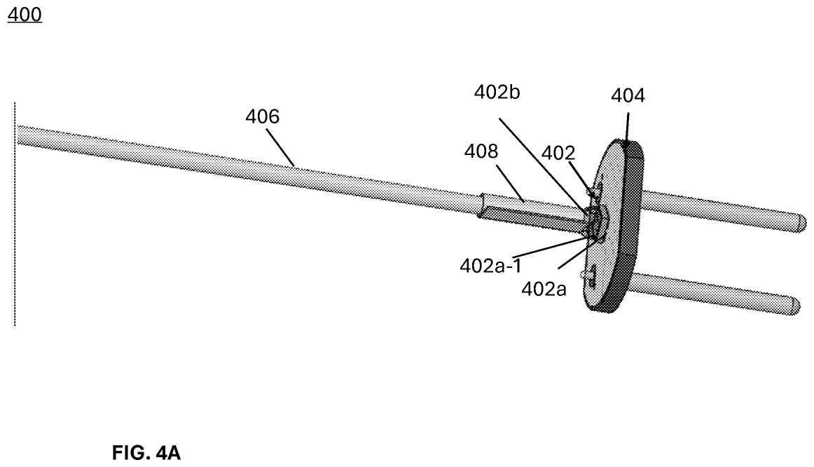

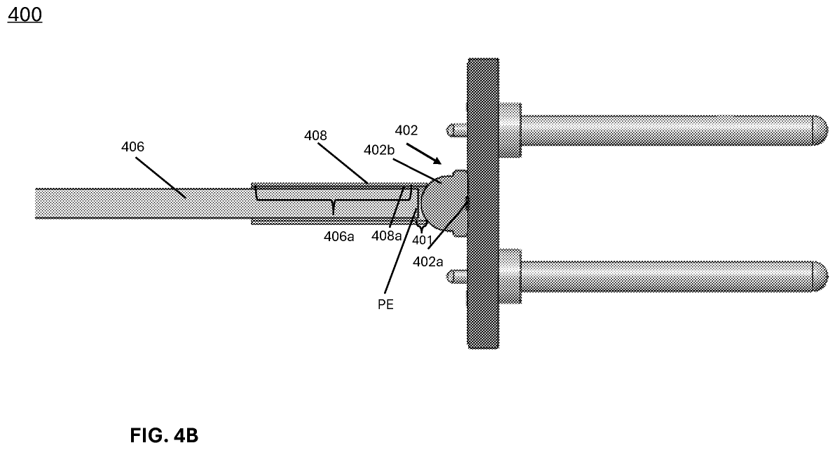

As noted above, in various embodiments, the coupling efficiency of light generated by a light source, such as, an LED, into an optical fiber is enhanced by utilizing a reflective surface that extends between the light source and at least the light-receiving surface of the optical fiber. By way of example, FIGS. 4A and 4B schematically illustrate an optical system 400 according to an embodiment, which includes an LED source 402 having a light emitting diode 402a, which is supported on a PCB 404 and includes a light-emitting surface 402a-1. The LED source 402 further includes a hemispherically-shaped lens 402b that is optically coupled to the light-emitting surface 402a-1. An optical fiber 406 can be optically coupled to the LED 402 by placing its light-receiving end (herein also referred to as its proximal end) in close proximity to the external surface of the LED's lens 402b. By way of example, in various embodiments, the distance between the proximal end of the optical fiber and the lens surface can be in a range of zero (i.e., the proximal end of the optical fiber touching the lens surface) to about 2 mm, e.g., about 1 mm. With particular reference to FIG. 4B, in this embodiment, a gap 401, which has a linear extent equal to or less than about 1 mm, separates the outer surface of the lens 402b from the proximal end (PE) of the optical fiber 406.

With particular reference to FIG. 4B, a light reflective element 408 having an inner reflective surface 408a spans the space between the LED's lens 402b and the optical fiber, extending beyond the optical fiber's proximal end to encompass a proximal portion 406a of the optical fiber. By way of example, and without limitation, in this embodiment the light reflective element is in the form of a flexible reflective film that includes an inner reflective surface exhibiting a reflectivity of at least a minimum reflectivity (that may have a value such as 95%, 96%, 97%, 98%, or 99%) for light having wavelengths in the visible portion of the electromagnetic spectrum. By way of example, and without limitation, a reflective film marketed by 3M™ corporation under the trade designation Enhanced Specular Reflector (ESR) can be utilized as the reflective element 408.

In various embodiments, the reflective element significantly improves the optical coupling efficiency between the LED and the optical fiber by redirecting light rays into the optical fiber that would otherwise escape, thus ensuring that a greater portion of the emitted light is received by the optical fiber. By way of example, in various embodiments, the combination of placing the proximal end of the optical fiber in close proximity to the LED and using the reflective element can result in an efficiency of at least about 5% (e.g., in a range of about 5% to about 20%, e.g., in a range of about 10% to about 15%) for the optical coupling between the LED and the optical fiber.

Although in this embodiment the LED lens 402b has a hemispherical surface, in other embodiments, the LED lens can have a flat surface.

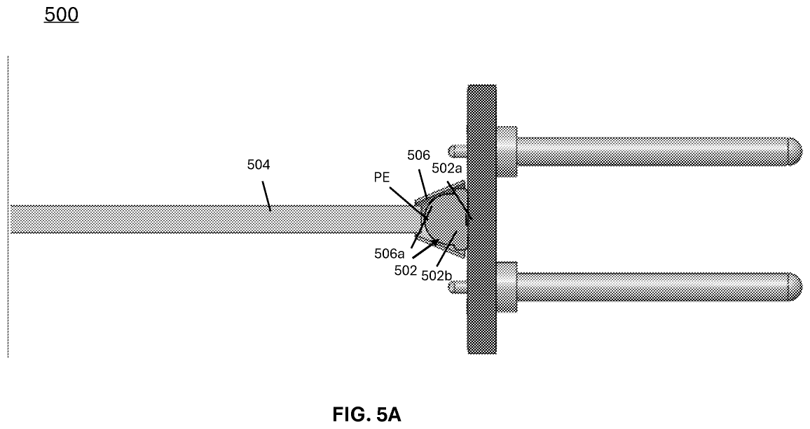

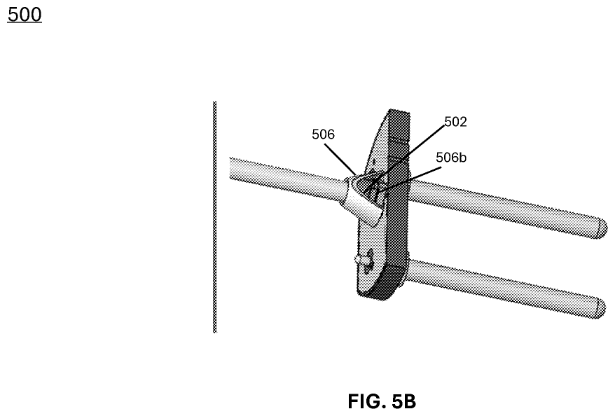

FIGS. 5A and 5B schematically depict an optical system 500 according to another embodiment. Optical system 500 includes an LED source 502 having a light-emitting diode 502a and a lens 502b, where the LED source 502 is optically coupled to the proximal end (PE) of an optical fiber 504 such that the optical fiber 504 receives at least a portion of the light emitted by the LED source 502.

A reflective element 506 having a truncated conical shape and an inner light reflective surface 506a spans the separation distance between the LED and the optical fiber 504 extending beyond the proximal end of the optical fiber to enclose a proximal portion of the optical fiber. Similar to the optical system 400, the reflective element 506 helps redirect at least a portion of the light rays that would not have entered the optical fiber in absence of the reflective element to the optical fiber, thereby improving the efficiency of the optical coupling between the LED and the optical fiber. By way of example, and without limitation, the reflective element can be formed from a glossy white Mylar HSF film.

With particular reference to FIG. 5B, in this embodiment, the reflective element has two opposed lateral windows, where one of those windows 506b is visible in this figure, which facilitate the dissipation of heat generated by the LED source. For example, such a feature can be useful in those implementations in which high power LEDs, e.g., LEDs operating at 40 watts (W) or 60 W, are used. In other embodiments, the reflective element 506 may not include such cooling windows.

As noted above, in various embodiments, an optical system according to the present teachings can include a first optical fiber that is in an efficient optical coupling, via a proximal end thereof, with a light source (e.g., an LED) to receive the light generated by the light source, where the optical coupling can be established, e.g., in a manner discussed above. The optical system further includes a second optical fiber that is optically coupled at its proximal end to the distal end of the first optical fiber to receive light exiting the first optical fiber.

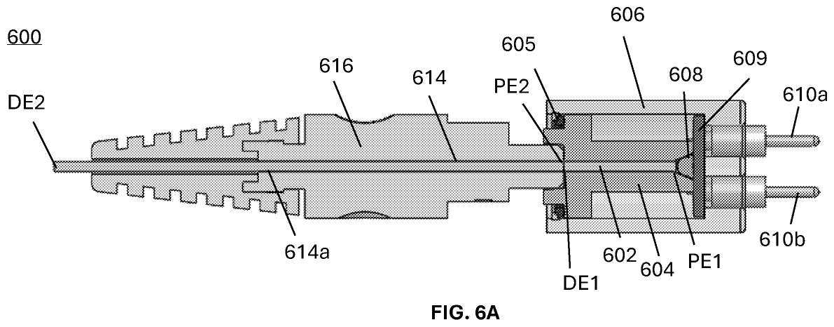

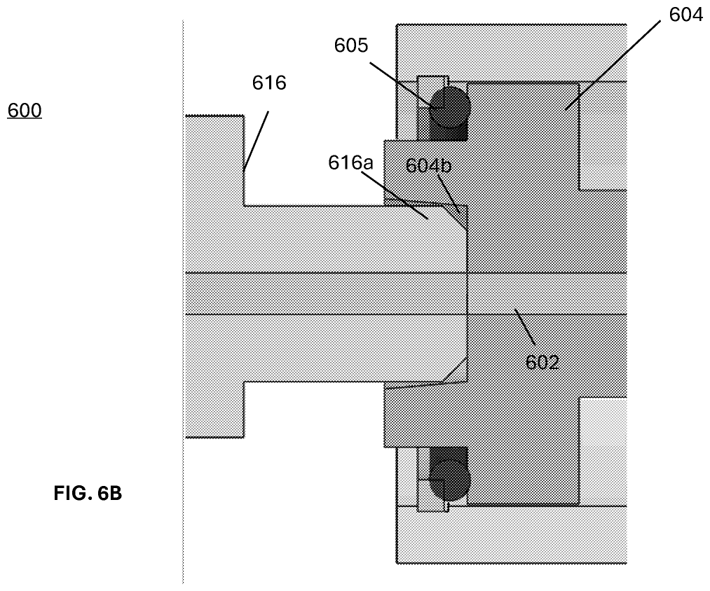

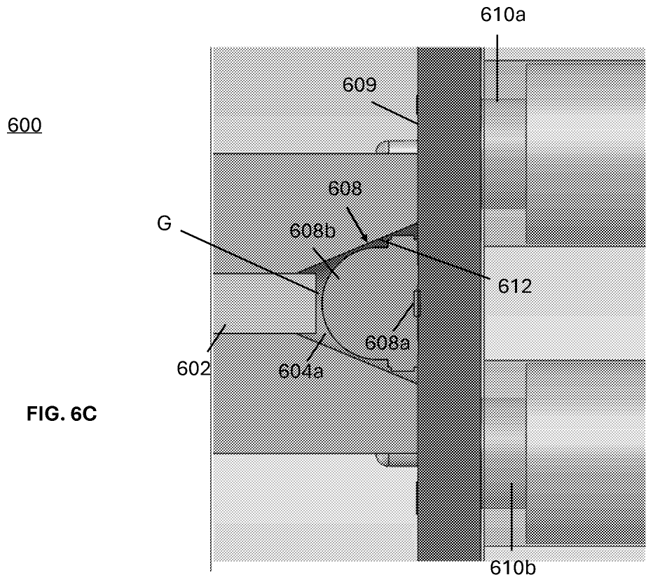

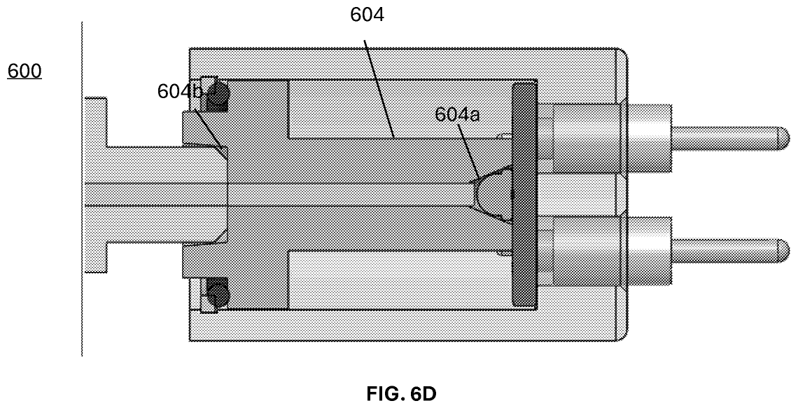

FIGS. 6A-6D depict an example of such an optical system 600 according to some embodiments. System 600 includes a first optical fiber 602 that extends from a proximal end (PE) to a distal end (DE) and that is positioned within a channel provided by a holder 604, which, in turn, is housed in a housing 606. An O-ring 605 helps seal the holder 604 against the housing 606. In some embodiments, the holder 604 can be formed of a white plastic material, by way of example.

An LED source 608 having a light emitting diode 608a and a lens 608b (See, e.g., FIG. 6C) is mounted on a PCB 609, where the LED source and the associated PCB are also housed within the housing 606. With particular reference to FIG. 6C, in this embodiment, the holder 604 provides a cavity 604a for receiving the LED source 608 such that a small gap (G) separates the LED lens surface from the proximal end of the optical fiber. By way of example, the separation distance can be equal to or less than about 1 mm. A pair of electrical conductors 610a and 610b extend through two openings formed in the housing 606 to provide electrical power to the PCB 609.

A light reflecting coating (e.g., in the form of white paint or a thin metal layer) 612 is deposited on an inner surface of the cavity 604a provided by the holder 604, where the reflecting coating provides a reflective surface that surrounds the LED source and terminates on the optical fiber slightly above the proximal end thereof. As in various embodiments, only the inner surface of the cavity 604a needs to be highly reflective, in some embodiments, the remainder of the holder may be formed of a less reflective material. In some embodiments, a thin clear window may be added or integrated into the output end of the holder 604 to protect the distal end of the optical fiber. In some embodiments, the holder 604 may be formed of a clear material (e.g., a clear plastic material) with an integrated output window feature.

Similar to the previous embodiments, the reflective element 612 helps improve the efficiency of the coupling of the light rays emitted by the LED source 608 into the first optical fiber 602.

With particular reference to FIG. 6A, the optical system 600 includes a second optical fiber 614 extending from a proximal end (PE2) to a distal end (DE2), which is positioned within a channel 614a of a second holder 616 (herein also referred as a connector), which provides strain relief and aligns the second optical fiber 614 with the first optical fiber 602 such that the proximal end (PE2) of the second optical fiber 614 is optically coupled to the distal end (DE1) of the first optical fiber 602 to receive the light exiting the first optical fiber. While in this embodiment, the proximal end (PE2) of the optical fiber 614 is in physical contact with the distal end (DE1) of the optical fiber 602, in other embodiments a small gap may separate the proximal end (PE2) of the optical fiber 614 from the distal end of the optical fiber 602.

More specifically and with particular reference to FIG. 6B, the holder 604 includes a recess 604b that is sized and shaped to accommodate a protruding portion 616a of the holder 616. In certain embodiments, the protruding portion 616a engages frictionally with the walls of the recess 604b, ensuring a secure mechanical coupling between the two holders. This robust connection helps maintain a precise alignment between the two optical fibers, enhancing overall stability and performance of the optical system.

By way of example, the fiber holders 604 and 616 can be formed via injection molding using, e.g., a high-reflectivity white plastic material. In this embodiment, the fiber holders 604 and 616 are formed as two separate pieces. In some cases, this can allow providing a tight-fitting of the first optical fiber within the holder 604 at both ends of that optical fiber. Further, a small outer diameter of the holder 604 at the location of the LED source can allow the holder to center the proximal end of the first optical fiber to the LED source even if the LED source is not concentric within the complete LED module.

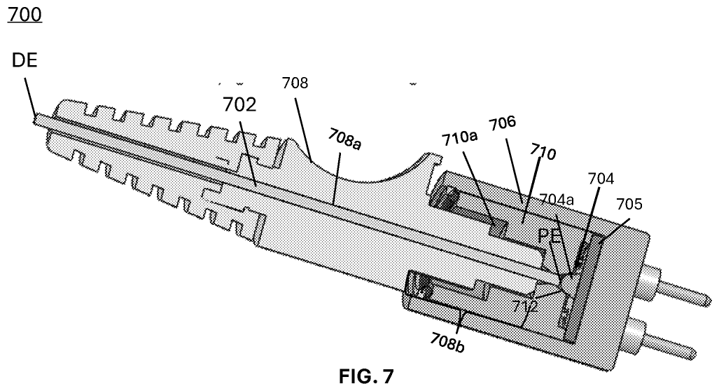

FIG. 7 schematically depicts an optical system 700 according to another embodiment, which includes a single optical fiber 702 extending from a proximal end PE to a distal end DE, where the proximal end (PE) of the optical fiber 702 is positioned in proximity to a lens 704a of an LED source 704 to receive at least a portion of the light emitted by the LED source. Similar to the previous embodiment, the LED source 704 is mounted on a PCB 705 and is positioned within a housing 706.

The optical fiber 702 is maintained within a channel 708a of a holder 708. The holder 708 includes a protruding stepped proximal portion 708b, which is received within a mating cavity 710a provided by a mating component 710 disposed within the housing 706 so as to place the proximal end (PE) of the optical fiber in close proximity (e.g., within about 1 mm) to the lens 704a of the LED source 704.

A reflective element 712 in the form of a truncated cone and having a reflective inner surface is optically coupled to the LED source 704 to improve the optical coupling between the LED source 704 and the optical fiber 702.

A variety of LED sources generating different colors can be employed in the practice of various embodiments of the present teachings. In addition, light sources other than LED sources, e.g., VCSELs (vertical cavity surface emitting lasers), can be employed in various embodiments of optical systems according to the present teachings.

The optical systems according to the present teachings can find a variety of applications. For example, they can be utilized in a variety of medical instruments. By way of example, and without limitation, optical systems according to various embodiments can be used as a light source in endoscopes.

The following examples are provided for further elucidation of various aspects of the present teachings and are not provided to necessarily indicate the optimal ways of practicing the present teachings and/or optimal results that may be obtained.

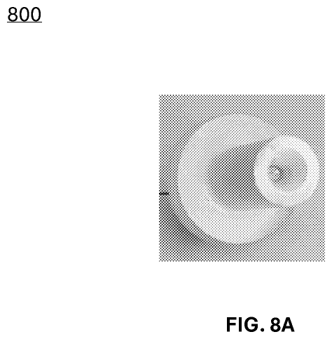

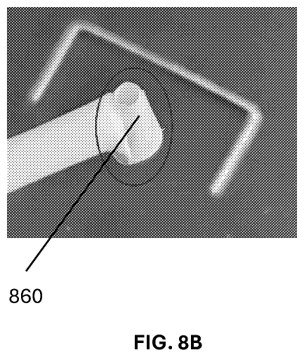

FIG. 8A is an image of a molded component 800 formed of Acrylic that has a structure similar to that of the holder 604 described above in FIGS. 6A-6D . The conical reflective surface was formed via a glossy white paint that improved the reflectivity of the painted surface.

FIG. 8B is an image of a reflective element 860 having a truncated conical profile, which was formed from Acrylic via a molding process. The reflectivity of the inner surface of the reflective element 860 was enhanced via the deposition of a glossy white paint on the inner surface of the conical element. In one experiment, adding the white reflective cone around an interface between an LED and an optical fiber resulted in an increase of about 14% in the intensity of the output light of the optical fiber (in this example, a fiber light output of about 9.0 lumens increased to a light output of about 10.3 lumens).

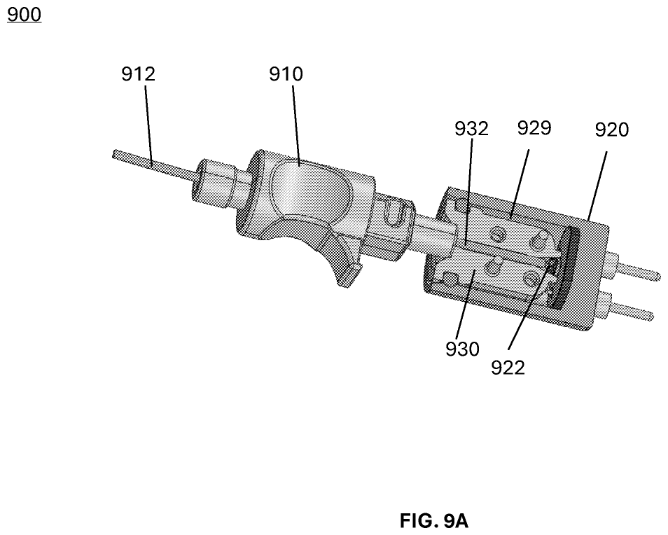

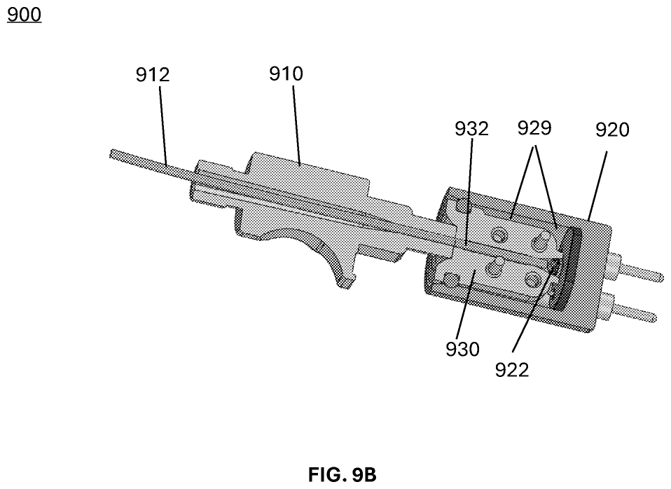

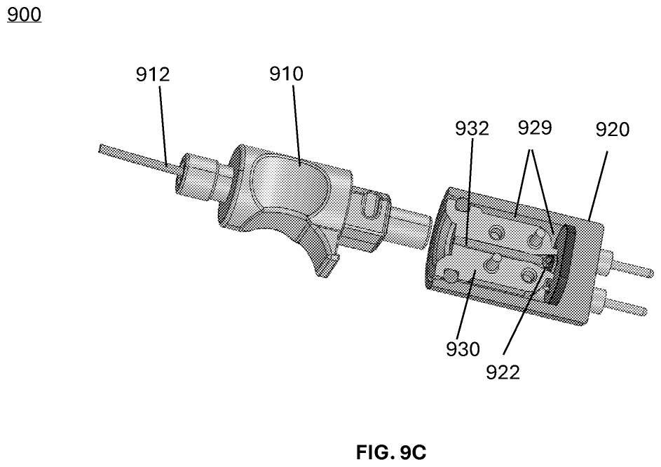

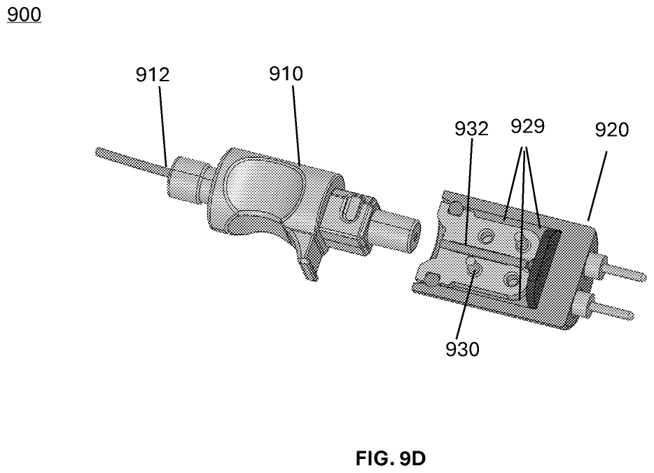

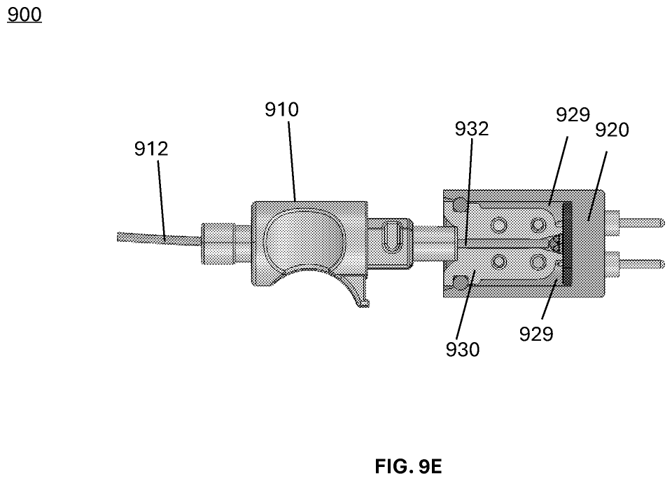

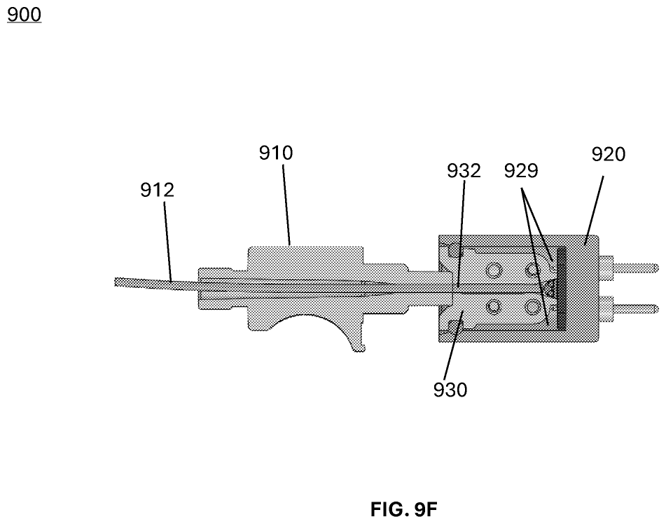

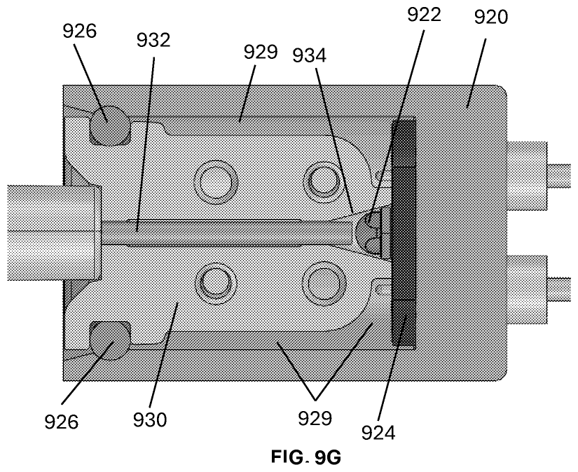

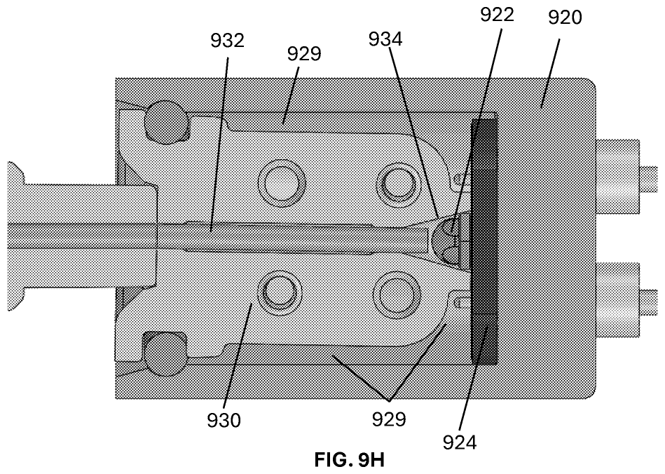

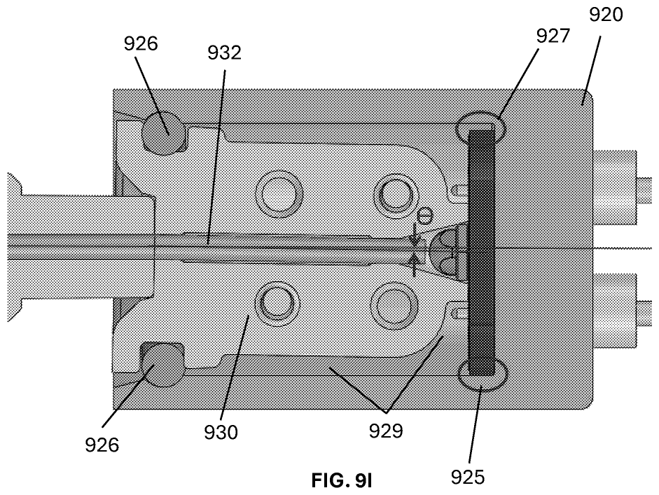

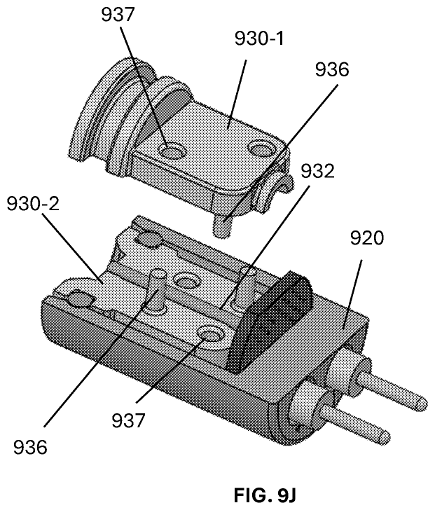

Referring to FIGS. 9A through 9J, an optical system 900 demonstrates an advanced configuration that incorporates self-alignment mechanisms and modular assembly features for enhanced optical coupling performance, according to some embodiments. Optical system 900 includes a first fiber holder 910 and a module housing 920. Module housing 920, in turn, includes a second fiber holder 930. In various embodiment, the self-alignment mechanism may include a fiber-light source alignment mechanism or specifically a fiber-LED alignment mechanism, as detailed below.

First fiber holder 910 may be configured to house and position a first optical fiber 912 within the system structure. First fiber holder 910 may provide mechanical support and alignment capabilities for first optical fiber 912 while facilitating connection with other system components. First optical fiber 912 may serve as a light transmission element that receives light from a light source and delivers the light to subsequent optical components within optical system 900. The positioning of first optical fiber 912 within first fiber holder 910 may allow for precise control of the fiber orientation and alignment relative to other optical elements in the system.

Module housing 920 may encompass multiple internal components and provide structural containment for the optical coupling mechanisms within optical system 900. For example, module housing 920 may be configured to protect internal components from environmental factors while maintaining proper alignment relationships between the various optical elements. An LED source 922 may be positioned within module housing 920 to provide light generation capabilities for optical system 900. LED source 922 may generate light across specific wavelength ranges depending on the semiconductor materials and construction used in the device.

As shown in FIG. 9G, for example, LED source 922 may be mounted on a printed circuit board 924 that provides electrical connectivity and mechanical support for the light-emitting components. Printed circuit board 924 may include conductive pathways and electrical connections that facilitate power delivery to LED source 922 while maintaining proper electrical isolation and thermal management.

Various mechanisms provide improved positioning and alignment of the light generation and transmission components within optical system 900, as further detailed below. For example, the positioning of LED source 922 within module housing 920 may be configured to facilitate optimal light coupling with optical fiber components while maintaining thermal management and electrical connectivity requirements.

Similarly, second fiber holder 930 may be disposed within module housing 920 to provide support and positioning for a second optical fiber 932. Second fiber holder 930 may be configured to maintain proper alignment of second optical fiber 932 relative to LED source 922 and other optical components within the system. Second optical fiber 932 may serve as an intermediate light transmission element that receives light from LED source 922 and transfers the light to first optical fiber 912 through optical coupling mechanisms.

The positioning of second optical fiber 932 within second fiber holder 930 may allow for control of the separation distance and alignment angle relative to LED source 922, thereby optimizing light collection efficiency within optical system 900. For example, an internal gap 929 may exist between module housing 920 and second fiber holder 930 to accommodate thermal expansion, mechanical tolerances, and alignment adjustments during operation. Internal gap 929 may provide clearance that allows second fiber holder 930 to move or tilt within module housing 920 while maintaining proper optical alignment between second optical fiber 932 and LED source 922. The presence of internal gap 929 may facilitate self-alignment mechanisms that compensate for manufacturing tolerances or positional variations in LED source 922 relative to module housing 920. In some cases, internal gap 929 may be sized to allow sufficient movement for alignment correction while preventing excessive displacement that could affect optical performance. In some embodiments, internal gap 929 may have a width around 0.2-1.0 mm.

The positioning of LED source 922 on printed circuit board 924 may also be configured to align with second optical fiber 932 when second fiber holder 930 is properly positioned within module housing 920. A sealing ring 926 may be positioned within module housing 920 to provide environmental sealing and mechanical support for the internal components. Sealing ring 926 may help prevent contamination or moisture ingress while allowing for controlled movement of second fiber holder 930 during alignment operations.

As another mechanism for positioning and alignment, second fiber holder 930 includes an internal cavity 934 that may be positioned near the location of second optical fiber 932 to accommodate LED source 922. Internal cavity 934 may be sized and shaped to receive LED source 922 while maintaining appropriate clearances for thermal expansion and mechanical tolerances. The geometric configuration of internal cavity 934 may facilitate proper positioning of second optical fiber 932 relative to LED source 922 to optimize light coupling efficiency. For example, internal cavity 934 may have a conical shape that provides self-aligning capability between LED source 922 and second optical fiber 932 when LED source 922 may not be centered within module housing 920. The conical shape of internal cavity 934 may create geometric constraints that guide second fiber holder 930 into proper alignment with LED source 922 through mechanical interaction between the cavity walls and the LED source structure.

As illustrated in FIG. 9I, the self-aligning mechanism of optical system 900 may compensate for positional variations in LED source 922 or printed circuit board 924 within module housing 920. When LED source 922 is not be perfectly centered within module housing 920, the conical internal surface of internal cavity 934 may cause second optical fiber 932 to automatically center on LED source 922 through mechanical interaction. An alignment gap 925 and a housing gap 927 may be present between printed circuit board 924 and the internal wall module housing 920. These gaps may indicate different cross-sectional clearances that accommodate the tilting motion of second fiber holder 930. The tilting capability may further be accommodated by sealing ring 926 and housing gap 927, allowing second optical fiber 932 to maintain proper alignment despite potential misalignment of LED source 922 within module housing 920. This fiber-LED alignment mechanism may reduce the probability of misalignment between LED source 922 and second optical fiber 932 while minimizing the degree of any residual misalignment that could affect optical performance. As illustrated in FIG. 9I, the self-aligning mechanism may result in a tilt by a small angle θ between the axes of module housing 920 and second fiber holder 930.

As further shown in FIG. 9F, first optical fiber 912 may be slightly bent or curved due to the flexible nature and extended length of the fiber structure. First optical fiber 912 may typically have a diameter of about 1 mm and a length that may be as long as 1 or 2 meters to provide sufficient reach for various application requirements. The flexible characteristics of first optical fiber 912 may allow the fiber to be routed through complex geometric configurations while maintaining optical transmission capabilities. Second optical fiber 932 may typically have a diameter of about 1 mm and a length in a range such as 9-11 mm, for example about 11 mm to provide appropriate light collection and transmission characteristics within the compact geometry of module housing 920. The shorter length of second optical fiber 932 may facilitate precise positioning and alignment within second fiber holder 930 while minimizing optical losses that could occur with longer fiber segments in the coupling region.

Referring to FIG. 9J, second fiber holder 930 may include a split holder configuration that facilitates assembly and maintenance operations within optical system 900. In particular, second fiber holder 930 may consist of a first holder half 930-1 and a second holder half 930-2 that may be configured as two identical fitting components. First holder half 930-1 and second holder half 930-2 may fit and lock together to sandwich second optical fiber 932 between the two halves, thereby providing secure mechanical support while allowing for disassembly when required. The split holder design may allow for precise positioning of second optical fiber 932 within second fiber holder 930 while facilitating manufacturing and assembly processes. Second optical fiber 932 may further include a locking mechanism to properly fit and lock the two halves with respect to each other. The locking mechanism may include one or more locking teeth 936 located on one or both of the two halves and one or more locking holes 937 located under counterpart half for each locking tooth. The locking mechanism between first holder half 930-1 and second holder half 930-2 may provide reliable mechanical connection while permitting separation for fiber replacement or system maintenance operations.

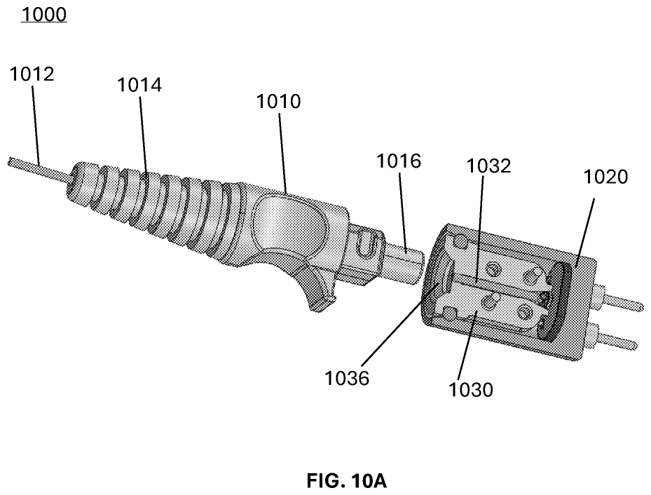

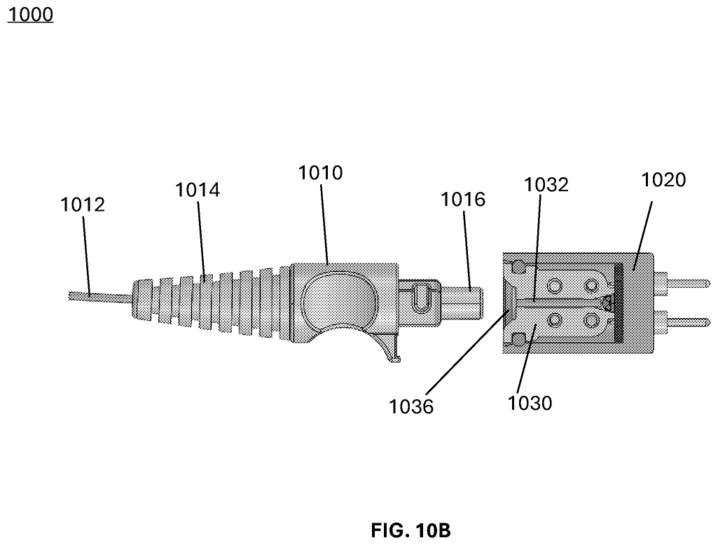

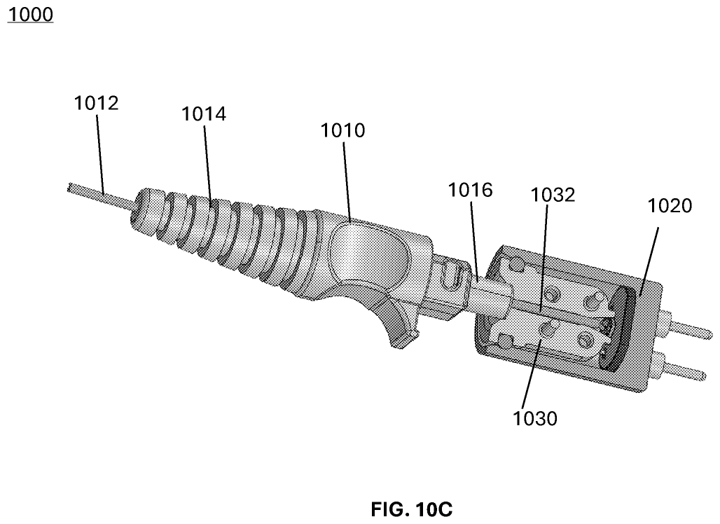

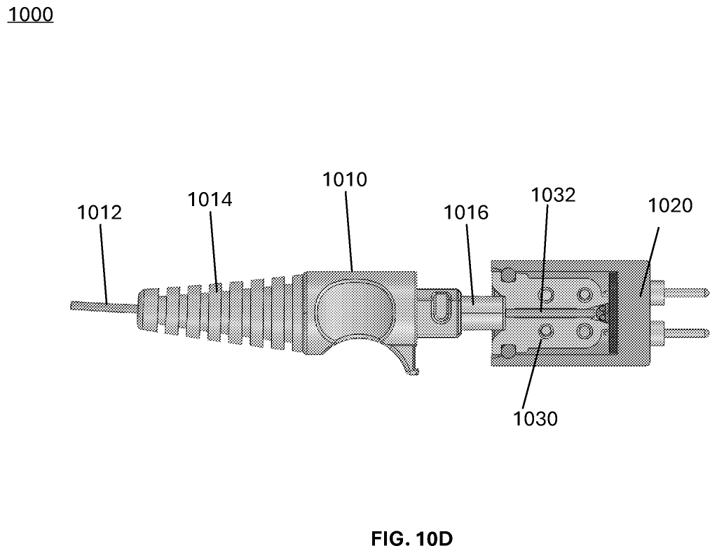

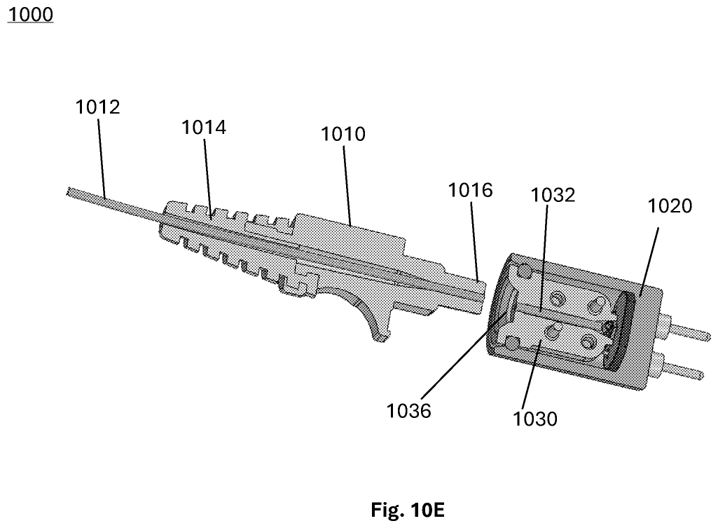

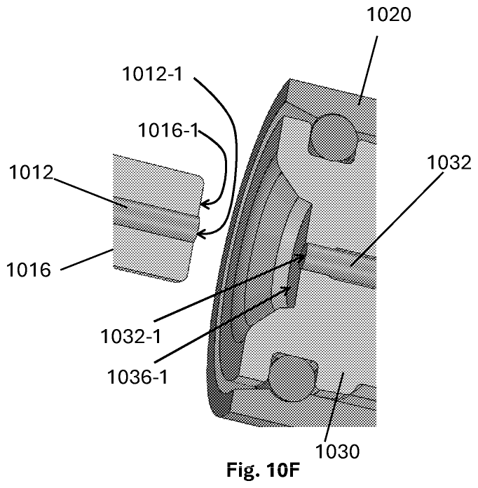

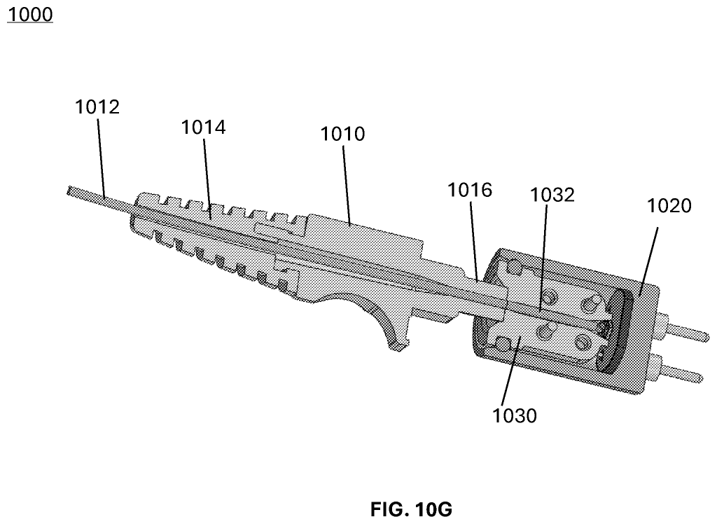

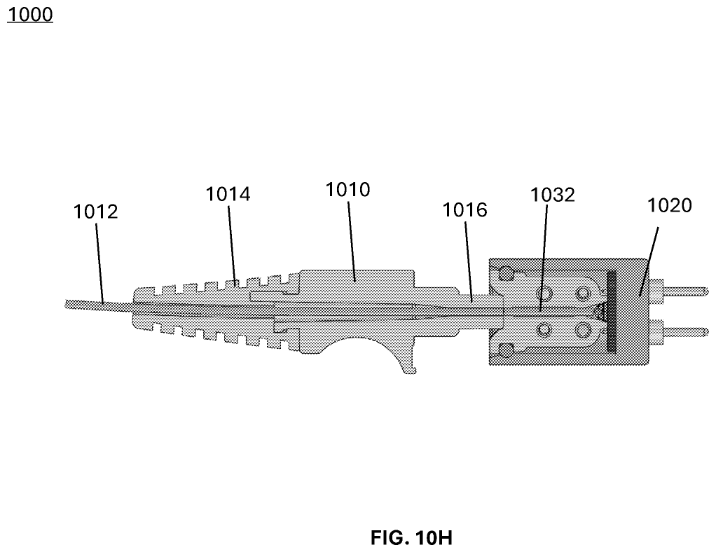

Referring to FIGS. 10A through 10H, an optical system 1000 demonstrates a connector-based configuration that incorporates modular assembly features and enhanced fiber alignment mechanisms for improved optical coupling performance according to some embodiments. In particular, some embodiments may utilize a connector protrusion-recession mechanism further detail below. Optical system 1000 includes a first fiber holder 1010 and a module housing 1020. Module housing 1020 houses a second fiber holder 1030 as further described below.

First fiber holder 1010 may be configured to house and position a first optical fiber 1012 within the system structure. In particular, first fiber holder 1010 may include a strain relief section 1014 and a connector protrusion 1016 as further detailed below. First fiber holder 1010 may provide mechanical support and alignment capabilities for first optical fiber 1012 while facilitating connection with other system components through integrated connector mechanisms. A connector mechanism may, for example, provide a mechanism for connecting first fiber holder 1010 to module housing 1020 or to second fiber holder 1030 such that the optical components such as optical fibers are properly aligned.

First optical fiber 1012 may serve as a light transmission element that receives light from optical components within optical system 1000 and delivers the light to external locations or applications. The positioning of first optical fiber 1012 within first fiber holder 1010 may allow for precise control of the fiber orientation and alignment relative to other optical elements in the system while accommodating the flexible nature of the fiber structure.

Strain relief section 1014 may be integrated into first fiber holder 1010 to provide mechanical protection and flexibility management for first optical fiber 1012. Strain relief section 1014 may include grooves or other geometric features that allow controlled bending and flexing of first optical fiber 1012 without exceeding the minimum bend radius limitations of the fiber structure. The flexible characteristics of strain relief section 1014 may help prevent mechanical damage to first optical fiber 1012 during installation, operation, or handling procedures. In some embodiments, strain relief section 1014 may be formed as an integral part of first fiber holder 1010 through molding processes that create the groove patterns and flexibility characteristics within the holder structure. The groove patterns within strain relief section 1014 may be configured to distribute bending stresses across multiple locations along the fiber length, thereby reducing localized stress concentrations that could affect optical performance or mechanical integrity.

Connector protrusion 1016 may extend from the main body of first fiber holder 1010 toward connection regions within optical system 1000. Connector protrusion 1016 may provide geometric features that facilitate mechanical and optical coupling with module housing 1020 while maintaining precise alignment relationships. The geometric configuration of connector protrusion 1016 may be tailored to engage with corresponding connector elements to establish secure mechanical connections while allowing for assembly and disassembly operations when required for maintenance or component replacement. Connector protrusion 1016 may include a first holder proximal surface 1016-1 that provides a reference plane for positioning first optical fiber 1012 relative to other optical components within the connector interface. First holder proximal surface 1016-1 may be configured to maintain consistent spacing and alignment relationships during connector engagement operations as further described below.

Module housing 1020 may encompass multiple internal components and provide structural containment for the optical coupling mechanisms within optical system 1000. Module housing 1020 may be configured to protect internal components from environmental factors while maintaining proper alignment relationships between the various optical elements. The structural design of module housing 1020 may accommodate the connector mechanisms while providing access for assembly and maintenance operations. Module housing 1020 may include mounting features and alignment references that facilitate proper positioning of internal components during manufacturing and assembly processes. In some cases, module housing 1020 may be formed from materials that provide electromagnetic shielding or thermal management capabilities depending on the specific application requirements and operating environment conditions.

Second fiber holder 1030 may be configured to maintain proper alignment of second optical fiber 1032 relative to other optical components within the system while facilitating connector engagement with first fiber holder 1010. Second optical fiber 1032 may serve as an intermediate light transmission element that receives light from light sources within module housing 1020 and transfers the light to first optical fiber 1012 through optical coupling mechanisms established by the connector interface. The positioning of second optical fiber 1032 within second fiber holder 1030 may allow for precise control of the fiber end positioning and alignment angle relative to connector protrusion 1016 when the connector elements are engaged.

In particular, second fiber holder 1030 may include a connector recession 1036 that may be sized and shaped to receive connector protrusion 1016 of first fiber holder 1010. Connector recession 1036 may provide geometric constraints that guide connector protrusion 1016 into proper alignment during connector engagement operations while establishing mechanical coupling between first fiber holder 1010 and second fiber holder 1030. The geometric configuration of connector recession 1036 may be tailored to accommodate manufacturing tolerances while maintaining precise alignment between first optical fiber 1012 and second optical fiber 1032. The disclosed features of connector recession 1036 provide mechanical retention of connector protrusion 1016 while allowing for controlled disengagement when required for system maintenance or component replacement operations. In particular, connector recession 1036 may have a truncated cone profile (seen, for example, in FIG. 10F) that guides and fits connector protrusion 1016 when first fiber holder 1010 is connected to second fiber holder 1030.

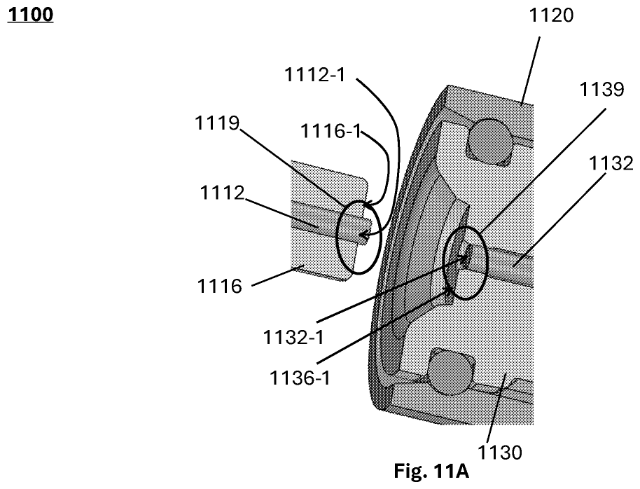

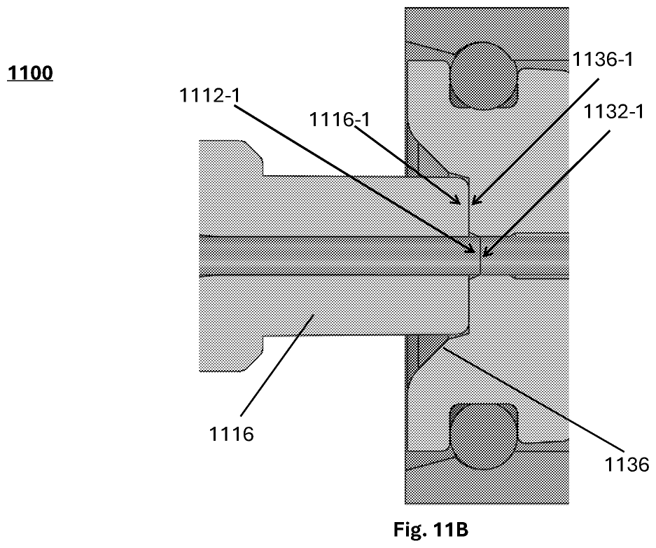

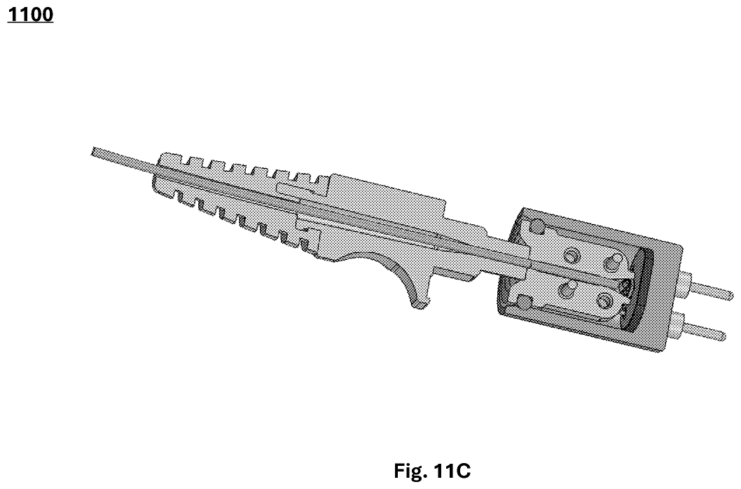

With continued reference to FIG. 10F, first optical fiber 1012 includes a first fiber proximal end 1012-1 that may be positioned relative to first holder proximal surface 1016-1 of connector protrusion 1016 to establish proper optical coupling relationships. First fiber proximal end 1012-1 may be configured to align with corresponding optical elements when connector protrusion 1016 engages with connector recession 1036. The positioning of first fiber proximal end 1012-1 relative to first holder proximal surface 1016-1 may be controlled during manufacturing processes to ensure consistent optical coupling performance across multiple connector engagement cycles. In some cases, first fiber proximal end 1012-1 may be positioned flush with first holder proximal surface 1016-1 to provide a planar interface that facilitates alignment with corresponding optical elements in the connector system. In some other embodiments, this positioning may be different as described, for example, in relation to FIGS. 11A-11B below.

Second optical fiber 1032 includes a second fiber distal end 1032-1 that may be positioned relative to a second holder distal surface 1036-1 of connector recession 1036 to establish proper optical coupling relationships with first optical fiber 1012. Second fiber distal end 1032-1 may be configured to align with first fiber proximal end 1012-1 when connector protrusion 1016 engages with connector recession 1036, thereby establishing an optical coupling path between the two fiber elements. The positioning of second fiber distal end 1032-1 relative to second holder distal surface 1036-1 may be controlled during manufacturing processes to minimize air gaps and alignment errors that could affect optical transmission efficiency. In some cases, second fiber distal end 1032-1 may be positioned flush with second holder distal surface 1036-1 to provide consistent reference surfaces for connector alignment operations.

As further shown in FIGS. 10A through 10H, the dimensional characteristics of first optical fiber 1012 and second optical fiber 1032 may be configured to provide appropriate optical transmission capabilities for the specific application requirements of optical system 1000. First optical fiber 1012 may have a diameter of about 1 mm and a length of about 1 or 2 meters to provide sufficient reach for various application requirements while maintaining optical transmission capabilities across the extended fiber length. The extended length of first optical fiber 1012 may allow the fiber to be routed through complex geometric configurations while providing flexibility for installation and positioning operations. Second optical fiber 1032 may have a diameter of about 1 mm and a length of about 11 mm to provide appropriate light collection and transmission characteristics within the compact geometry of module housing 1020. The shorter length of second optical fiber 1032 may facilitate precise positioning and alignment within second fiber holder 1030 while minimizing optical losses that could occur with longer fiber segments in the coupling region. The diameter matching between first optical fiber 1012 and second optical fiber 1032 may help minimize optical losses at the connector interface while maintaining consistent numerical aperture characteristics throughout the optical transmission path.

FIGS. 11A-11C show an enhanced fiber-fiber alignment mechanism 1100 according to some embodiments. In particular, some embodiments may utilize a fiber protrusion-recession mechanism detailed below. Alignment mechanism 1100 demonstrates advanced connector configurations that provide improved optical coupling precision between optical fiber components. Fiber-fiber alignment mechanism 1100 may address alignment challenges that may occur when optical fiber ends are positioned in close proximity for light transmission applications. Proper alignment between optical fiber components may be particularly important for maintaining consistent optical coupling efficiency and minimizing light losses that could occur due to lateral displacement or angular misalignment between fiber ends. Alignment mechanism 1100 provides geometric features that guide optical fiber components into proper alignment during connector engagement operations while accommodating manufacturing tolerances and assembly variations.

Alignment mechanism 1100, in addition to connector protrusion and connector recession features described above, utilizes a protrusion and a recession related to the optical fiber ends, as detailed below. Alignment mechanism 1100 includes a connector protrusion 1116, housing a first optical fiber 1112; and a module housing 1120 housing a second fiber holder 1130 that in turn houses a second optical fiber 1132 and forms a connector recession 1136 fitting a connector protrusion 1116. First optical fiber 1112 includes a first fiber proximal end 1112-1 that may serve as the light transmission interface for the fiber component. Connector protrusion 1116 may provide structural support and positioning control for first optical fiber 1112 within the connector assembly. Connector protrusion 1116 includes a first holder proximal surface 1116-1 that may serve as a reference plane for positioning first optical fiber 1112 relative to other optical components within the connector interface. The geometric relationship between first fiber proximal end 1112-1 and first holder proximal surface 1116-1 may be configured to facilitate proper optical coupling when the connector components are engaged with corresponding mating elements.

In particular, first fiber proximal end 1112-1 of first optical fiber 1112 may protrude beyond first holder proximal surface 1116-1 of connector protrusion 1116, as indicated within a first oval 1119. The protruding configuration of first fiber proximal end 1112-1 may provide geometric advantages for establishing direct contact with corresponding optical fiber components while minimizing air gaps that could reduce optical transmission efficiency. The protrusion distance of first fiber proximal end 1112-1 beyond first holder proximal surface 1116-1 may be controlled during manufacturing processes to ensure consistent optical coupling performance across multiple connector engagement cycles. In various embodiments, the protrusion distance may be in the range of around 0.2-1.0 mm. In some cases, the protruding configuration may allow first optical fiber 1112 to establish physical contact with corresponding optical elements before the connector housing components reach their fully engaged positions.

Module housing 1120 may provide structural containment and alignment references for the connector components within the optical system. In particular, module housing 1120 may be configured to accommodate the connector mechanisms while maintaining proper alignment relationships between the various optical elements during engagement operations. Second fiber holder 1130 may be positioned within or relative to module housing 1120 to provide support and positioning control for optical fiber components that mate with first optical fiber 1112. Second fiber holder 1130 may include geometric features, such as connector recession 1136 and other features described below, that complement the connector protrusion 1116 configuration to establish secure mechanical and optical coupling between fiber components.

Second optical fiber 1132 may be positioned within second fiber holder 1130 to provide optical coupling capabilities with first optical fiber 1112. Second optical fiber 1132 includes a second fiber distal end 1132-1 that may serve as the light receiving interface for the fiber component. The positioning of second fiber distal end 1132-1 within second fiber holder 1130 may be configured to align with first fiber proximal end 1112-1 when the connector components are properly engaged. Second fiber holder 1130 includes a second holder distal surface 1136-1 that may provide a reference plane for positioning second optical fiber 1132 relative to the connector interface. The geometric relationship between second fiber distal end 1132-1 and second holder distal surface 1136-1 may be configured to complement the protruding configuration of first optical fiber 1112 and facilitate proper optical alignment during connector engagement.

In particular, second fiber distal end 1132-1 of second optical fiber 1132 may be recessed relative to second holder distal surface 1136-1 of second fiber holder 1130, with a chamfered portion visible within a second oval 1139. The recessed configuration of second fiber distal end 1132-1 may create a receiving cavity that accommodates the protruding first fiber proximal end 1112-1 of first optical fiber 1112 during connector engagement operations. The chamfered portion indicated within second oval 1139 may provide geometric guidance that helps direct first fiber proximal end 1112-1 into proper alignment with second fiber distal end 1132-1 as the connector components are brought together. The chamfer geometry may create tapered surfaces that gradually guide first optical fiber 1112 toward the center axis of second optical fiber 1132, thereby reducing the likelihood of lateral misalignment during connector engagement.

Referring to FIG. 11B, the cross-sectional view illustrates the detailed geometric relationships between the connector components and optical fiber positioning within the alignment mechanism. Connector protrusion 1116 may be configured with precise dimensional control to ensure proper engagement with corresponding connector elements while maintaining optical alignment between first optical fiber 1112 and second optical fiber 1132. First holder proximal surface 1116-1 of connector protrusion 1116 may provide a reference plane that establishes the baseline position for the connector interface, while first fiber proximal end 1112-1 extends beyond this reference plane to facilitate direct fiber-to-fiber contact. The protruding configuration of first fiber proximal end 1112-1 may allow the fiber end to penetrate into the receiving cavity created by the recessed positioning of second fiber distal end 1132-1.

A connector recession 1136 may be configured to receive connector protrusion 1116 during engagement operations while providing geometric constraints that maintain proper alignment between the optical fiber components. Connector recession 1136 may include second holder distal surface 1136-1 that serves as a reference plane for positioning second optical fiber 1132 within the connector assembly. The geometric configuration of connector recession 1136 may be tailored to accommodate the dimensional characteristics of connector protrusion 1116 while providing appropriate clearances for manufacturing tolerances and thermal expansion. Second fiber distal end 1132-1 of second optical fiber 1132 may be positioned to recess from second holder distal surface 1136-1, creating a receiving cavity that accommodates first fiber proximal end 1112-1 when the connector components are fully engaged.

As shown in FIG. 11C, the fiber-fiber alignment mechanism may function through the coordinated interaction between the protruding and recessed fiber end configurations combined with the chamfered guidance surfaces. When connector protrusion 1116 engages with connector recession 1136, the chamfered surfaces within the connector recession may guide first fiber proximal end 1112-1 of first optical fiber 1112 toward proper alignment with second fiber distal end 1132-1 of second optical fiber 1132. The chamfer geometry may extend from the plane of second holder distal surface 1136-1 to the plane of second fiber distal end 1132-1, creating a tapered transition that facilitates gradual alignment correction as the connector components are brought together. This configuration may reduce the possibility of forming air gaps between the ends of the two optical fibers at their connection point while improving the concentricity and angular alignment between the fiber components.

In some embodiments, the relation between the protruding and receiving fiber ends may be reversed. That is, in some embodiments, the first fiber proximal end may recede from the first holder proximal surface and create a cavity, while the second fiber distal end may protrude from the second holder distal surface and create a protrusion to fit into the cavity.

The fiber-fiber alignment mechanism demonstrated in FIGS. 11A through 11C may provide measurable improvements in optical coupling consistency compared to configurations where both fiber ends are positioned flush with their respective connector surfaces. The protruding and recessed fiber end configuration may allow for direct fiber-to-fiber contact that minimizes optical losses while the chamfered guidance surfaces help ensure proper alignment even when manufacturing tolerances or assembly variations are present. In some cases, the alignment mechanism may accommodate lateral misalignments of several hundred micrometers while still maintaining acceptable optical coupling efficiency through the geometric guidance provided by the chamfered surfaces and the direct contact established between first fiber proximal end 1112-1 and second fiber distal end 1132-1.

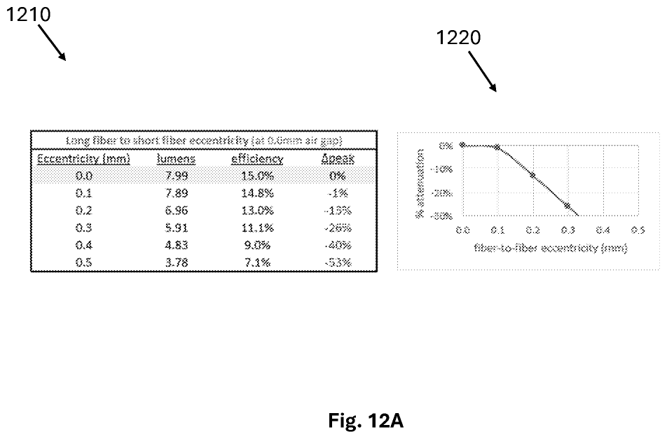

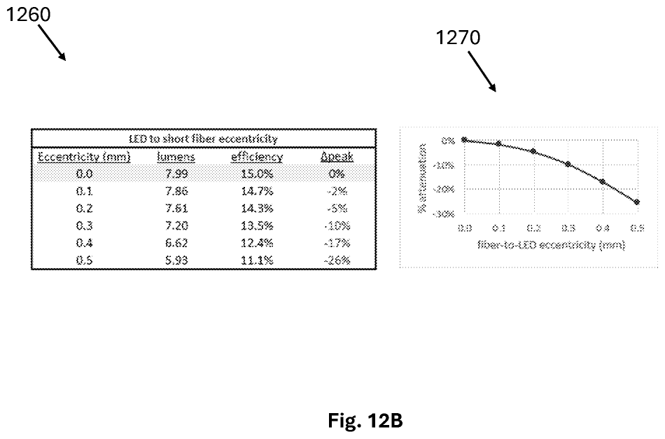

The alignment mechanisms in various embodiments may result in measurable improvements in optical transmission efficiency. FIGS. 12A and 12B show examples of measuring the adverse effect of misalignments on the efficiency according to some embodiments. In particular, FIGS. 12A and 12B respectively show the results of measuring the decrease in optical efficiency as a function of fiber to fiber misalignment and fiber to LED misalignment. To derive the listed results, in an optical system with six different configurations were created by changing the degree of the misalignment and, for each configuration, the corresponding physical quantity (detailed below) was measured.

Performance data demonstrates the relationship between fiber-to-fiber alignment precision and optical transmission efficiency in some optical coupling systems. The data presents measurements of light attenuation as a function of lateral displacement between optical fiber ends when the fibers are positioned with zero air gap separation. The experimental results, detailed below, show that even small misalignments between fiber ends can result in measurable reductions in light transmission efficiency.

More specifically, FIG. 12A includes a table 1210 and a graph 1220. To derive the data, and optical system such as those described above was illuminated by an LED light source with a known light output (in this case 54 lumens). Further, for each of the six configurations listed, the output of the system was measured, that is, the luminescence of the light exiting the distal end of the longer (labeled above as the first) optical fiber. In these measurements, the optical fiber had a 1 mm diameter.

In table 1210, the first column lists values of the eccentricity between the two fibers (in millimeters) as the variable among different configurations. The eccentricity was defined as the size of the section of the fiber diameters not overlapping each other. That is, 0.0 mm eccentricity indicates that the two diameters fully overlapped while 0.5 mm eccentricity indicates that around half of the diameters did not overlap causing around half of the light existing one fiber not entering the other fiber. The second column lists the luminescence of the output of the system. The third column lists the efficiency defined as the ratio of the system output to the input, that is, the output of the light source. And the last column (defined as the peak change) lists the decrease in the output divided by the output at 0.0 eccentricity.

Table 1210 shows that as the eccentricity increases linearly from 0.0 mm to 0.5 mm, the luminosity decreases from 7.99 to 3.78, the efficiency decreases from 15.0% to 7.1%, and the peak change decreases from 0% to −53%. The tabulated data indicates that fiber-to-fiber eccentricity values ranging from 0.0 mm to 0.5 mm produce corresponding changes in optical output performance, where negative attenuation increases progressively as the lateral displacement between fiber ends increases. In the table FIG. 12A the LED produced 53 lumens, so the 7.99 lumens measured at the output of the long fiber is the baseline achieved when the long fiber is perfectly aligned with (concentric with) and touching the short fiber. It is 15% of 53 lumens. When for example the long fiber is moved 0.3 mm off-center (but still touching) to the short fiber, the output from the long fiber dropped to 5.91 lumens. 5.91 lumens is 26% less than 7.99 lumens.

Graph 1220 the percentage attenuation plotted against fiber-to-fiber eccentricity measurements, revealing a general decrease in the optical performance as a result of misalignment between the 2 fibers. More specifically, the data points demonstrate that a lateral misalignment of 0.2 mm between fiber ends results in approximately 13% light loss compared to perfectly aligned fiber configurations. When the fiber-to-fiber eccentricity increases to 0.3 mm, the light attenuation reaches approximately 26%, indicating that alignment precision becomes increasingly important as misalignment distances increase. The experimental measurements suggest that maintaining fiber-to-fiber alignment within tight tolerances may provide substantial benefits for optical transmission efficiency in fiber coupling applications.

The performance data in FIG. 12A underscores the importance of the fiber-fiber alignment mechanism described in previous optical system configurations. The protruding and recessed fiber end configuration combined with chamfered guidance surfaces may address the alignment challenges demonstrated by the experimental data. The chamfered surfaces within connector recession components may provide geometric guidance that helps maintain fiber-to-fiber eccentricity within acceptable ranges, thereby minimizing the light losses shown in the performance measurements. In some cases, the alignment mechanism may accommodate manufacturing tolerances and assembly variations while maintaining optical coupling efficiency within desired performance ranges.

FIG. 12B shows changes in the same physical quantities as functions of the eccentricity between the second optical fiber and the LED according to some embodiments. More specifically, FIG. 12B includes a table 1260 and a graph 1270. Table 1260 lists measurements of luminosity, efficiency, and the peak change as functions of the eccentricity between the second fiber and the LED in manner similar to table 1210. In particular, table 1260 shows that as the eccentricity linearly increases from 0.0 mm, the luminosity decreases from 7.99 to 5.93 lumens, the efficiency decreases from 15.0% to 11.1%, and the peak change decreases from 0% to −26%. Moreover, graph 1270 shows a graph of the change in the attenuation as a function of fiber to LED eccentricity. In particular, graph 1270 shows that the attenuation decreases, nonlinearity, from 0% to around −25% as the eccentricity increases from 0.0 mm to 0.5 mm.

Referring to FIG. 12B, additional performance data illustrates the relationship between LED-to-fiber alignment precision and optical transmission efficiency in light source coupling applications. The graph shows the percentage attenuation as a function of lateral displacement between LED sources and optical fiber entrance regions, where the measurements demonstrate how positional accuracy affects light collection efficiency. The experimental data reveals that LED-to-fiber eccentricity produces attenuation characteristics that may differ from fiber-to-fiber alignment effects due to the different geometric and optical properties of LED light sources compared to optical fiber components. The red curve in the graph indicates specific measurement points taken at regular eccentricity intervals, providing quantitative data for evaluating alignment tolerance requirements in LED coupling systems.

The performance measurements in FIG. 12B demonstrate that a lateral misalignment of 0.3 mm between LED sources and optical fiber components results in approximately 10% light loss compared to properly aligned configurations. As the LED-to-fiber eccentricity increases to 0.5 mm, the attenuation reaches approximately 26%, indicating that alignment precision becomes increasingly important for maintaining optical coupling efficiency. The data suggests that LED-to-fiber alignment tolerances may have different sensitivity characteristics compared to fiber-to-fiber alignment requirements, where the specific geometric and optical properties of LED sources may influence the relationship between lateral displacement and light transmission efficiency. The experimental results provide guidance for establishing alignment tolerance specifications in optical coupling systems that incorporate LED light sources.

As further shown in FIG. 12B, the performance data highlights the importance of the self-aligning mechanisms described in previous optical system configurations for LED-to-fiber coupling applications. The conical internal cavity geometry within fiber holder components may address the alignment challenges demonstrated by the experimental measurements. When LED sources may not be perfectly centered within module housing components, the conical surfaces may provide mechanical guidance that helps maintain LED-to-fiber alignment within acceptable tolerance ranges. The self-aligning capability may help minimize the light losses shown in the performance data by automatically compensating for positional variations in LED sources or mounting components during assembly and operation.

The combined performance data from FIG. 12A and FIG. 12B demonstrates that both fiber-to-fiber alignment and LED-to-fiber alignment contribute to overall optical system efficiency in multi-component coupling configurations. The experimental measurements indicate that misalignment effects may be cumulative in systems that incorporate both types of optical interfaces, where alignment errors at multiple connection points can compound to produce greater overall light losses. The data suggests that maintaining proper alignment at both the LED-to-fiber interface and the fiber-to-fiber interface may provide optimal optical transmission performance. In some cases, the alignment mechanisms described in previous optical system configurations may work together to address both types of alignment challenges, where the self-aligning LED coupling mechanism and the fiber-fiber alignment mechanism may complement each other to maintain overall system performance within desired efficiency ranges.

Those having ordinary skill will appreciate that various changes may be made to the above embodiments without departing from the scope of the disclosure.

Although some aspects have been described in the context of a system or an apparatus, in some embodiments these aspects may also represent a description of the corresponding method, where a block or device corresponds to a method step or a feature of a method step. Analogously, aspects described in the context of a method step may also represent in some embodiments a description of a corresponding block or item or feature of a corresponding apparatus.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature exists in one or more embodiments but not necessarily in all embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or.

Moreover, if these terms are used, a set may include one or more members, and a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed compositions, systems, methods, and apparatus are not limited to any specific aspect or feature or combinations thereof, nor do the disclosed compositions, systems, methods, and apparatus require that any one or more specific advantages be present or problems be solved. Any theories of operation are to facilitate explanation, but the disclosed compositions, systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Moreover, subsets of elements or parts of different embodiments may be combined, if feasible, to create new embodiments not disclosed. Such embodiments may also include disclosed methods for which the elements or parts include method steps.

Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. An optical system comprising:
a printed circuit board (PCB);
a light source attached to the PCB;
an optical fiber including a proximal end and a distal end; and
a fiber holder configured to house the optical fiber and to receive the light source when the fiber holder is attached to the PCB,
wherein the fiber holder provides a fiber-light source alignment mechanism configured to align the proximal end of the optical fiber with the light source.

2. The optical system of claim 1, wherein:
the fiber-light source alignment mechanism includes an internal cavity defined by the fiber holder;
the fiber holder is configured to position the proximal end of the optical fiber in the internal cavity; and
the fiber holder is configured to receive the light source inside the internal cavity when the fiber holder is attached to the PCB such that the proximal end of the optical fiber is aligned with the light source.

3. The optical system of claim 1, further comprising a module housing configured to house the fiber holder and the PCB, wherein:
the module housing defines an internal gap formed between an internal wall of the module housing and an external surface of the fiber holder when the module housing houses the fiber holder; and
the internal gap is configured to provide an alignment space between the module housing and the fiber holder when the fiber holder is attached to the PCB.

4. The optical system of claim 3, wherein:
the fiber holder is as second fiber holder and the optical fiber is as second optical fiber; and
the optical system further includes:
a first optical fiber including a proximal end and a distal end; and
a first fiber holder configured to house the first optical fiber;
wherein:
the first fiber holder and the second fiber holder are configured to optically connect the proximal end of the first optical fiber to the distal end of the second optical fiber when the first fiber holder is attached to the module housing.

5. The optical system of claim 4, further comprising a fiber-fiber alignment mechanism.

6. The optical system of claim 5, wherein:
the first fiber holder includes a proximal end;
the second fiber holder includes a distal end configured to attach to the proximal end of the first fiber holder when the first fiber holder is attached to the second fiber holder; and
the fiber-fiber alignment mechanism includes:
a connector protrusion formed on the proximal end of the first fiber holder; and
a connector recession formed on the distal end of the second fiber holder configured to receive the connector protrusion when the first fiber holder is attached to the module housing.

7. The optical system of claim 6, wherein:
the first fiber holder connector protrusion includes a first holder proximal surface;
the second fiber holder distal end includes a second holder distal surface;
the first fiber holder is configured such that the proximal end of the first optical fiber protrudes from the first holder proximal surface when the first fiber holder houses the first optical fiber, forming a first optical fiber protrusion;
the second fiber holder is configured such that the distal end of the second optical fiber recesses from the second holder distal surface when the second fiber holder houses the second optical fiber forming a second optical fiber recession; and
the second fiber holder is configured such that when the first fiber holder is attached to the module housing the first optical fiber protrusion fits inside the second optical fiber recession.

8. An optical system comprising:
a printed circuit board (PCB);
a light source attached to the PCB;
an optical fiber including a proximal end and a distal end; and
a fiber holder configured to:
house the optical fiber and to receive the light source when the fiber holder is attached to the PCB; and
receive a proximal end of an external optical fiber;
wherein the fiber holder provides a fiber alignment mechanism configured to align the distal end of the optical fiber with the proximal end of the external optical fiber.

9. The optical system of claim 8, wherein:
the fiber holder is as second fiber holder;
the external optical fiber is at first optical fiber;
the optical fiber is as second optical fiber; and
the optical system further includes:
a first fiber holder configured to house the first optical fiber;
wherein:
the first fiber holder and the second fiber holder are configured to optically connect the proximal end of the first optical fiber to the distal end of the second optical fiber when the first fiber holder is attached to the second fiber holder.

10. The optical system of claim 9, further comprising a fiber-fiber alignment mechanism.

11. The optical system of claim 10, wherein:
the first fiber holder includes a proximal end;
the second fiber holder includes a distal end configured to attach to the proximal end of the first fiber holder when the first fiber holder is attached to the second fiber holder; and
the fiber-fiber alignment mechanism includes:
a connector protrusion formed on the proximal end of the first fiber holder; and
a connector recession formed on the distal end of the second fiber holder configured to receive the connector protrusion when the first fiber holder is attached to the second fiber holder.

12. The optical system of claim 11, wherein:
the first fiber holder connector protrusion includes a first holder proximal surface;
the second fiber holder distal end includes a second holder distal surface;
the first fiber holder is configured such that the proximal end of the first optical fiber protrudes from the first holder proximal surface when the first fiber holder houses the first optical fiber, forming a first optical fiber protrusion;
the second fiber holder is configured such that the distal end of the second optical fiber recesses from the second holder distal surface when the second fiber holder houses the second optical fiber forming a second optical fiber recession; and
the second fiber holder is configured such that when the first fiber holder is attached to the second fiber holder the first optical fiber protrusion fits inside the second optical fiber recession.
